(19) United States
(12) Patent Application Publication
(10) Pub. No.: US 2021/0320810 A1
(43) Pub. Date: Oct. 14, 2021

(54) VOLUMETRIC CONVERSATIONAL SERVICES USING NETWORK EDGE

(71) Applicant: Samsung Electronics Co., Ltd., Suwon-si (KR)

(72) Inventors: Prakash Kolan, Plano, TX (US); Rajan Laxman Joshi, San Diego, CA (US); Madhukar Budagavi, Plano, TX (US); Youngkwon Lim, Allen, TX (US)

(21) Appl. No.: 17/225,007

(22) Filed: Apr. 7, 2021

Related U.S. Application Data
(60) Provisional application No. 63/008,275, filed on Apr. 10, 2020.

(51) Int. Cl. H04L 12/18; H04L 29/06; G06T 19/20

(52) U.S. Cl. CPC H04L 12/1827; H04L 65/4053; G06T 19/20; H04L 67/38

(57) ABSTRACT

An apparatus includes a communication interface and a processor for providing volumetric conversational service. The communication interface receives a signaling message, from a plurality of user equipment (UEs), indicating a capability of the UEs to process participant volumetric content. The processor is operably coupled to the communication interface and identifies a conference associated with the UEs for which volumetric processing is requested. The processor further provisions a plurality of media resource functions in edge application servers of edge data networks for processing the participant volumetric content from the UEs. The processor assigns one or more of the UEs to a respective media resource function of the media resource functions. Additionally, the processor instructs the participant volumetric content received from the UEs to the media resource functions. The processor instructs conference volumetric content converted by the respective media resource functions to the UEs for the conference.

### CROSS-REFERENCE TO RELATED APPLICATION AND PRIORITY CLAIM

This application claims priority under 35 U.S.C. § 119(e) to U.S. Provisional Patent Application No. 63/008,275 filed on Apr. 10, 2020, which is hereby incorporated by reference in its entirety.

### TECHNICAL FIELD

This disclosure relates generally to volumetric processing devices and processes. More specifically, this disclosure relates to systems and methods for volumetric conversational service using network edge.

### BACKGROUND

The 3rd Generation Partnership Project (3GPP) has standardized conversational conference services in mobile operator networks. However, as of now, the services are primarily two-dimensional (2D) video services where the video of a conference participant is captured and sent to a conference media server which combines such videos received from multiple participants into one 2D video and sends the 2D video to all participants. Some development is occurring regarding offering virtual reality (VR) based conferences. However, there is no existing work which deals with conversational services using volumetric content (e.g., AR objects), which can be due to the amount of computation that is required for processing volumetric content.

### SUMMARY

This disclosure provides system and methods for volumetric conversational service using an edge network.

In an embodiment, an apparatus provides for volumetric conversational service. The apparatus includes a communication interface and a processor operably couple to the communication interface. The communication interface is configured to receive a signaling message from each of a plurality of user equipment (UEs), the signaling messages indicating a capability of the plurality of UEs, respectively, to process participant volumetric content. The processor is configured to identify a conference associated with the plurality of UEs for which volumetric processing is requested. The processor also is configured to provision a plurality of media resource functions in edge application servers of edge data networks for processing the participant volumetric content from the plurality of UEs. The processor is further configured to assign one or more of the plurality of UEs to a respective media resource function of the plurality of media resource functions. Additionally, the processor is configured to instruct the participant volumetric content received from the plurality of UEs to the plurality of media resource functions. The processor is further configured to instruct conference volumetric content converted by the respective media resource functions to the one or more UEs for the conference.

In another embodiment, a media resource function in an edge network is provided for volumetric conversational service. The media resource function includes a communication interface and a processor operably couple to the communication interface. The communication interface is configured to receive a signaling message from an apparatus in a core network to provision the media resource function for processing volumetric content from one or more user equipments (UEs), the signaling messages indicating a capability of the one or more UEs assigned to the media resource function, respectively, to process participant volumetric content. The processor is configured to identify a conference associated with the one or more UEs for which volumetric processing is requested. The processor is also configured to receive the participant volumetric content received from the one or more UEs assigned to the media resource function. In addition, the processor is configured to mix the participant volumetric content with other participant volumetric content into conference volumetric content. The processor is further configured to transmit the conference volumetric content to the one or more UEs for the conference.

In yet another embodiment, a UE is provided for receiving volumetric conversational services. The UE includes a communication interface and a process operably coupled to the communication interface. The processor is configured to transmit, to a network configuration server, a signaling message indicating capability of the UE to process participant volumetric content for a conference with a plurality of UEs. The processor is also configured to receive, based on the signaling message, an assignment to a media resource function in an edge application server data network provisioned for processing the participant volumetric content for the UE. The processor is further configured to transmit the participant volumetric content to the media resource function. Additionally, the processor is configured to receive conference volumetric content converted from other participant volumetric content corresponding to one or more UEs for the conference by the media resource function. The processor is further configured to render the converted conference volumetric content for the conference.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with an embodiment of this disclosure;

FIGS. 2 and 3 illustrate example electronic devices in accordance with an embodiment of this disclosure;

FIG. 4 illustrates an example architecture for enabling edge application in accordance with this disclosure;

FIG. 5 illustrates an example Internet protocol (IP) multimedia subsystem (IMS) conference function split in accordance with this disclosure;

FIG. 6 illustrates example IMS deployment option in a network edge in accordance with this disclosure;

FIG. 7 illustrates an example IMS two-way call using a network edge in accordance with this disclosure;

FIG. 8 illustrates an example IMS conference call using a network edge in accordance with this disclosure;

FIG. 9 illustrates an example message flow for an IMS conference call using a network edge in accordance with this disclosure;

FIGS. 10A and 10B illustrate example media processing at multiple levels in accordance with this disclosure; and

FIG. 11 illustrates an example method for systems and methods for volumetric conversational service using a network edge according to this disclosure.

### DETAILED DESCRIPTION

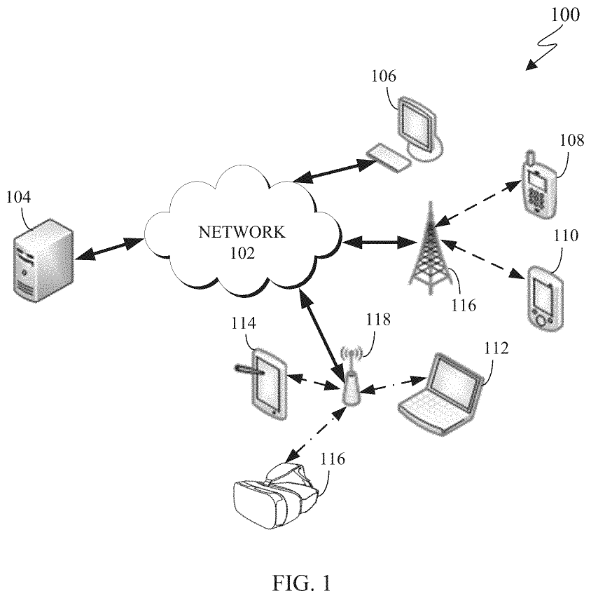

FIGS. 1 through 11, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

Edge computing-based solutions are being increasingly applied for complex workloads where bulk of the processing happens in an edge network, and the devices that need complex processing offloads such computation to edge devices. A number of organizations such as 3GPP, moving pictures experts group (MPEG), European Telecommunications Standards Institute (ETSI), etc. have studied architectures for edge processing. This application discusses realization of complex volumetric conversational services using network edge architectures.

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included a given device is increasing. Even with the increase of processing power portable electronic devices often struggle to provide the processing capabilities to handle new services and applications, as newer services and applications often require more resources that is included in a portable electronic device. Improved methods and apparatus for configuring and deploying media processing in the network is required.

Cloud media processing is gaining traction where media processing workloads are setup in the network (e.g., cloud) to take advantage of advantages of the benefits offered by the cloud such as (theoretically) infinite compute capacity, auto-scaling based on need, and on-demand processing. An end user client can request a network media processing provider for provisioning and configuration of media processing functions as required.

The figures discussed below, and the various embodiments used to describe the principles of the present disclosure in this' patent document are by way of illustration only and should not be construed in any way to limit the scope of the disclosure. Those skilled in the art will understand that the principles of the present disclosure may be implemented in any suitably-arranged system or device.

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can transmit conference volumetric content, representing one or more other participant volumetric content mixed into an empty scene, to one or more display devices, such as a client device 106-116. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and an HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. The HMD 116 can display a 360° scene including conference volumetric content corresponding to one or more other participant volumetric content mixed into an empty scene. In certain embodiments, any of the client devices 106-116 can include an encoder, decoder, or both. For example, the mobile device 108 can record a video and then encode the video enabling the video to be transmitted to one of the client devices 106-116. In another example, the laptop computer 112 can be used to generate a virtual 3D point cloud, which is then encoded and transmitted to one of the client devices 106-116.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can be used to capture participant volumetric content, transmit the participant volumetric content to a server 104, receive conference related content including other participant volumetric content corresponding to another client device such as any client device 106-116, and render the conference volumetric content for the conference.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

In certain embodiments, any of the client devices 106-116 or the server 104 can receive signaling messages, identify a conference related to the signaling message, assign client device 106-116 to media resource functions, direct participant volumetric content to respective media resource functions, send conference volumetric content, or a combination thereof. For example, a server 104 can process and mix participant volumetric content into conference volumetric content and then transmit the conference volumetric content to one or more of the client devices 106-116. For another example, one of the client devices 106-116 can transmit participant volumetric content related to a user's participation for a conference and then render conference participant content related to other participation volumetric content corresponding to another one of the client devices 106-116 or empty scene description corresponding to the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

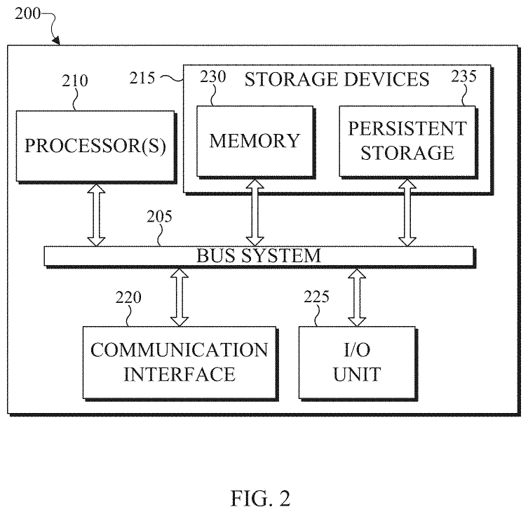

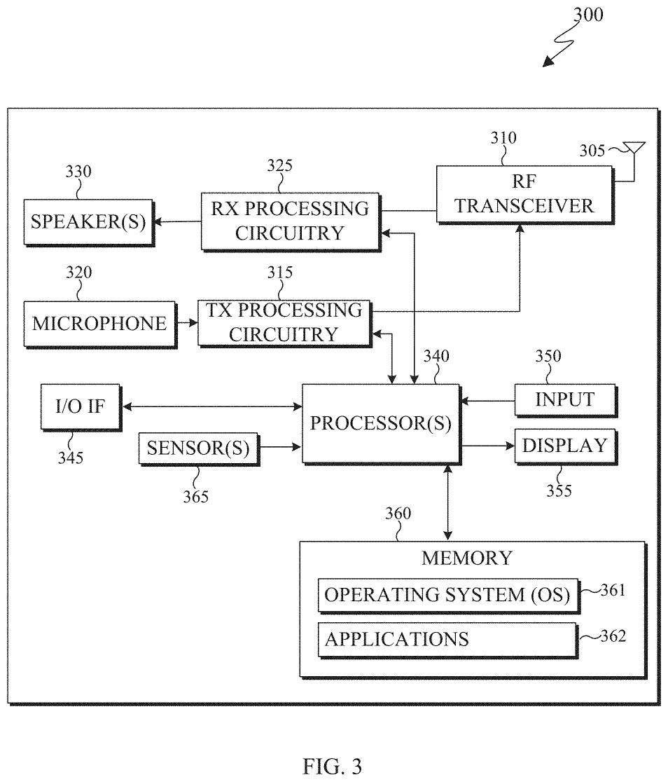

FIGS. 2 and 3 illustrate example electronic devices in accordance with an embodiment of this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225. The server 200 can represent one or more local servers, one or more compression servers, or one or more encoding servers, such as an encoder. In certain embodiments, the encoder can perform decoding.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry. In certain embodiments, the processor 210 can encode a volumetric content within the storage devices 215. In certain embodiments, encoding a volumetric content also decodes the volumetric content to ensure that when the participant content is reconstructed, the reconstructed participant content matches the volumetric content prior to the encoding.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random-access memory or any other suitable volatile or non-volatile storage device(s). For example, the instructions stored in the memory 230 can include instructions for decomposing a point cloud into patches, instructions for packing the patches on 2D frames, instructions for compressing the 2D frames, as well as instructions for encoding 2D frames in a certain order in order to generate a bitstream. The instructions stored in the memory 230 can also include instructions for rendering a 360° scene, as viewed through a VR headset, such as HMD 116 of FIG. 1. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud, such as participant volumetric content, to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within an HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

The electronic device 300 can create media content such as generate a virtual object or capture (or record) content through a camera. To transmit the media content to another device, the electronic device 300 can compress and encode the content. When preparing the media content to be transmitted, the electronic device 300 can project the point cloud into multiple patches. For example, a cluster of points of the point cloud can be grouped together and depicted as a patch in a 2D frame. A patch can represent a single attribute of the point cloud, such as geometry, color, and the like. Patches that represent the same attribute can be packed into individual 2D frames, respectively.

The 2D frames are then encoded to generate a bitstream. The frames can be encoded individually or together. During the encoding process additional content such as metadata, flags, occupancy maps, auxiliary information, and the like can be included in the bitstream. The electronic device 300 can encode the media content to generate a bitstream, such that the bitstream can be transmitted directly to another electronic device or indirectly such as through the network 102 of FIG. 1. Another electronic device, similar to the electronic device 300, can receive a bitstream directly from the electronic device 300 or indirectly such as through the network 102 of FIG. 1.

Similarly, when decoding media content included in a bitstream that represents a 3D point cloud, the electronic device 300 decodes the received bitstream into frames. In certain embodiments, the decoded bitstream also includes an occupancy map. The decoded bitstream can also include one or more flags, or quantization parameter size, auxiliary information, or any combination thereof. A geometry frame can include pixels that indicate geographic coordinates of points of the point cloud in 3D space. Similarly, a color frame can include pixels that indicate the RGB color of each geometric point in 3D space. In certain embodiments, an individual frame can include points from different layers. In certain embodiments, after reconstructing the 3D point cloud, the electronic device 300 can render the 3D point cloud in three dimensions via the display 355.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

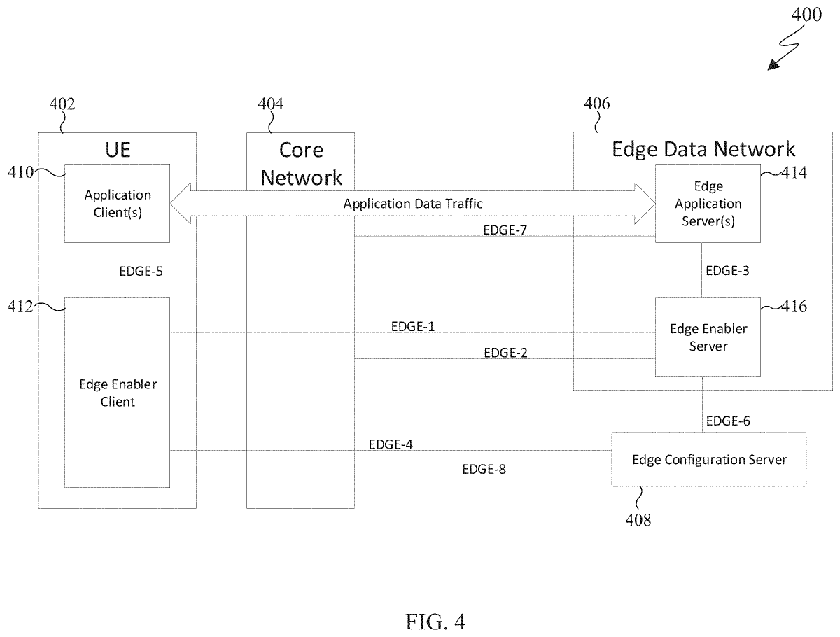

FIG. 4 illustrates an example architecture 400 for enabling edge application in accordance with this disclosure. The embodiment of the architecture 400 illustrated in FIG. 4 is for illustration only. FIG. 4 does not limit the scope of this disclosure to any particular implementation of an electronic device.

Volumetric content services are future media services that require enormous amount of processing (compute capacity) and bandwidth for transmission. However, media processing of volumetric content may not be possible in some of today's mobile terminals. 5G networks offer enough bandwidth to provide some volumetric services to end users. As a result, network processing of volumetric content is required before the final volumetric content is sent to users for consumption. Edge processing helps with such a requirement.

A number of sub-working groups in 3GPP have either studied or currently studying edge deployment as an enabler for providing services to end users that were other difficult to offer due to latency and buffering requirements. A working group is currently standardizing an application layer architecture for enabling edge applications as shown in FIG. 4.

As shown in FIG. 4, The architecture 400 includes network components 402-408 and interfaces 410-416 between those network components that can offer edge-based applications. The network components 402-408 can include a UE 402, a core network 404, an edge network 406, and an edge configuration server (ECS) 408. The interfaces 410-416 can include an application client 410, an edge enabler client 412, an edge application server 414, and an edge enabler server (EES) 416.

The UE 402 is a device that generates volumetric content related to a user and transmits the volumetric content to the edge network. The UE 402 receives mixed volumetric content of other users in a conference setting and renders the volumetric content in the conference setting. The UE 402 can include the application client 410 and the edge enabler client 412.

The core network 404 can assign the UE 402 to a specific node in the edge network 406. The core network 404 can direct volumetric content from the UE 402 and other UE to an edge network 406.

The edge network 406 can include media resource functions that operate to process and mix the volumetric content from the UE 402 and mix the content of other UE into a conference scene that is provided back to the UE 402. The edge network 406 can include the edge application server 414 and the EES 416.

The ECS 408 is a configuration server deployed in the edge network 406 to offer services to edge enabler client 412 to discover the appropriate EES 416 and edge application servers 414. The ECS 408 provides supporting functions needed for the edge enabler client 412 to connect with an EES 416. The ECS 408 can provision of Edge configuration information to the edge enabler client 412. The configuration information can include information for the edge enabler client 412 to connect to the EES 416 and information for establishing a connection with EES s 416. The ECS 408 can support the functionalities of registration (i.e., registration, update, and de-registration) for the EES(s) 416.

The application client 410 is a client at the UE 402 (e.g., an app) that the service provider requires the users to have to use the service. The application client 410 is the application resident in the UE 402 performing client function(s).

The edge enabler client 412 is a client at the UE 402 that interfaces with services deployed at the mobile operator edge to provide required data to the application client 410. The edge enabler client 412 abstracts the delivery of data to the application client 410, so the application client 410 does not know whether the data is being retrieved through edge network 406, core network 404, or service provider network. The edge enabler client 412 can retrieve and provision configuration information to enable the exchange of application data traffic with the edge application server 414.

The edge application server 414 is an application server deployed in the edge network 406 for the mobile operator. The edge application server 414 is the application server resident in the edge network 406, performing the server functions. The application client 410 of UE 402 can connect to the edge application server 414 in order to avail the services of the application with the benefits of edge computing.

The EES 416 provides supporting functions to enable exchange of traffic between edge enabler client 412 and edge application server 414. Such functions include discovery of edge application server 414, connection management between edge enabler client 412, ECS 408, and edge application servers 414.

The EES 416 can provision configuration information to the edge enabler client 421, enabling exchange of application data traffic with the edge application server 414. The EES 416 can interact with 3GPP core network 404 for accessing the capabilities of network functions. The EES 416 can support external exposure of 3GPP network and service capabilities to the edge application server(s) 414; support functionalities of registration (i.e., registration, update, and de-registration) for the edge enabler client(s) 412 and the edge application server(s) 414; and support the functionalities of triggering the edge application server instantiation on demand.

Although FIG. 4 illustrate an architecture 400 for enabling edge application, various changes may be made to FIG. 4. For example, the sizes, shapes, and dimensions of the architecture 400 and its individual components can vary as needed or desired. Also, the number and placement of various components of the architecture 400 can vary as needed or desired. In addition, the architecture 400 may be used in any other suitable volumetric conferencing process and is not limited to the specific processes described above.

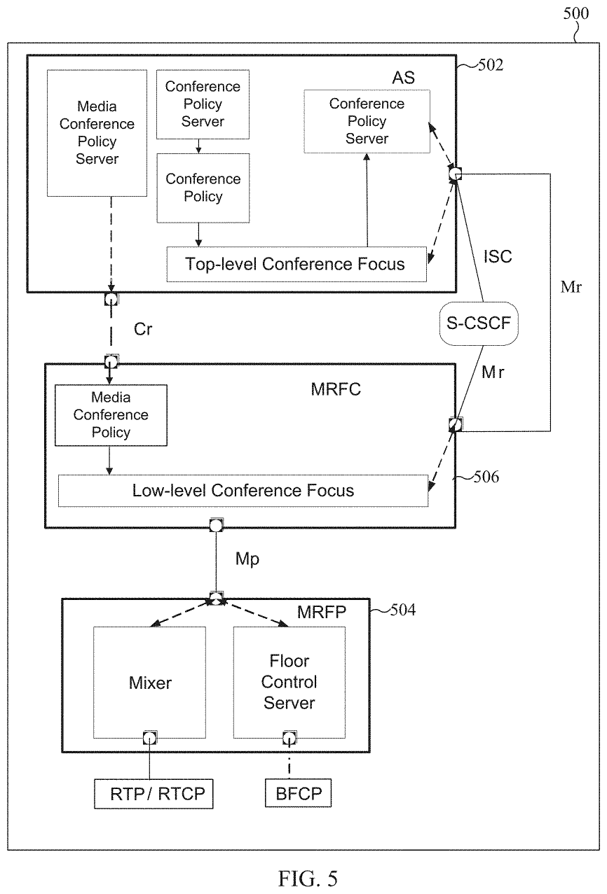

FIG. 5 illustrates an example IMS conference function split 500 in accordance with this disclosure. The embodiment of the IMS conference function split 500 illustrated in FIG. 5 is for illustration only. FIG. 5 does not limit the scope of this disclosure to any particular implementation of an electronic device.

As shown in FIG. 5, the IMS conference function split 500 provides for SIP based conferences between a conferencing application server 502, a media resource function controller 504, a media gateway control function 506. The conference function split 500 provides for the functionality of conferencing in an IMS system.

The conferencing application server 502 implements a role of a conference focus and a conference notification service. The conferencing application server 502 can implement a role of a conference participant.

The media resource function controller 504 implements a role of conference participant. The media resource function controller 504 implements functions except the “REFER” function for SIP based conferences.

The media gateway control function 506 supports procedures for ad-hoc conferencing and procedures for media control of ad-hoc conferencing. media resource function controller 504 classifies the media gateway control function 506 as a mixer.

Although FIG. 5 illustrates an IMS conference function split 500, various changes may be made to FIG. 5. For example, the sizes, shapes, and dimensions of the IMS conference function split 500 and its individual components can vary as needed or desired. Also, the number and placement of various components of the IMS conference function split 500 can vary as needed or desired. In addition, the IMS conference function split 500 may be used in any other suitable volumetric conferencing process and is not limited to the specific processes described above.

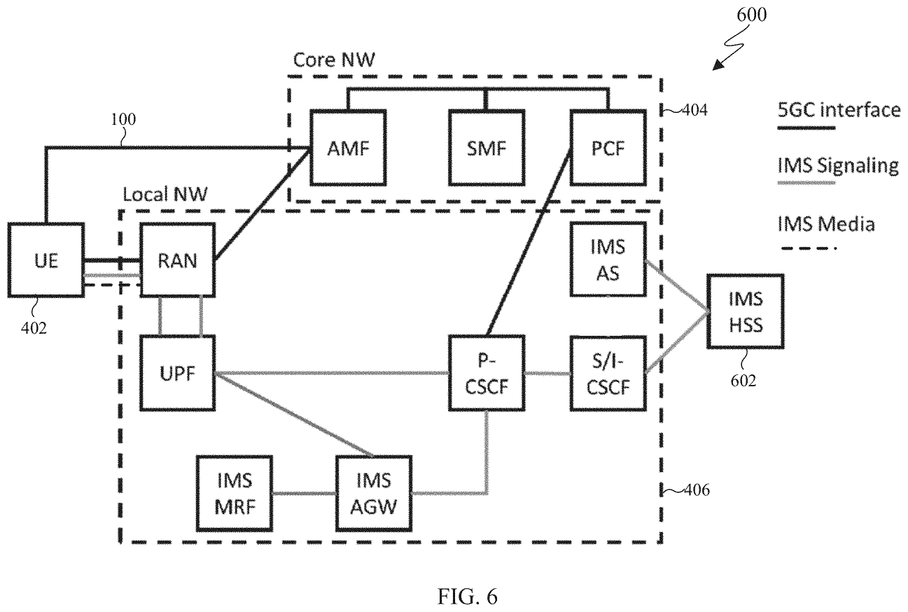

FIG. 6 illustrates example IMS deployment option 600 in a network edge in accordance with this disclosure. The embodiment of the IMS deployment option 600 illustrated in FIG. 6 are for illustration only. FIG. 6 does not limit the scope of this disclosure to any particular implementation of an electronic device.

As shown in FIG. 6, the IMS 602 can be set up in the edge network 406. 3GPP TR 23794 defines a candidate architecture for running IMS services in 5G network edge. However, there is no existing literature for setting up IMS conference calls using volumetric content at network edge.

Although FIG. 6 illustrate a IMS deployment options 600, various changes may be made to FIG. 6. For example, the sizes, shapes, and dimensions of the IMS deployment options 600 and its individual components can vary as needed or desired. Also, the number and placement of various components of the IMS deployment options 600 can vary as needed or desired. In addition, the IMS deployment options 600 may be used in any other suitable volumetric conferencing process and is not limited to the specific processes described above.

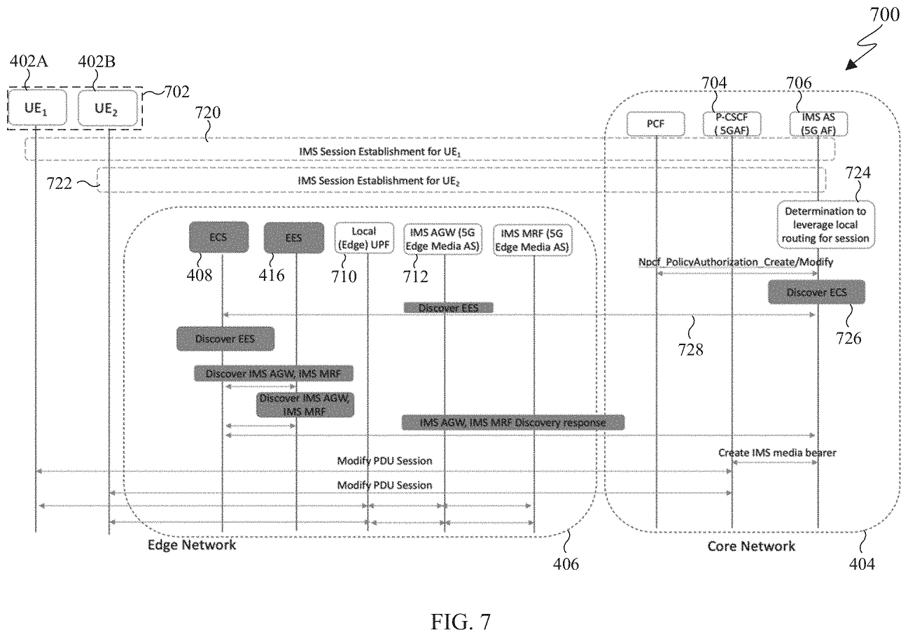

FIG. 7 illustrates an example IMS two-way call 700 using a network edge in accordance with this disclosure. The embodiment of the IMS two-way call 700 illustrated in FIG. 7 is for illustration only. FIG. 7 does not limit the scope of this disclosure to any particular implementation of an electronic device.

As shown in FIG. 7, a two-way IMS call 700 between two users 702 can be setup using network edge 406. The core network 404 can include a P-CSCF (5G AF) 704, and an IMS AS 706. The edge network 406 can include an ECS 408, and EES 416, an edge UPF (e.g., 5G User Plane Function) 710, and IMS access gateway (AGW) servers 712,

In step 720, an IMS session is setup between the IMS AS 706, P-CSCF 704 and a first UE 402A. In step 722, an IMS session is setup between the IMS AS 706, P-CSCF 704 and a second UE 402B. Steps 720 and 722 are described in 3GPP TS 24.147 and TS 24.229.

In step 724, the IMS 706 AS in core network determines that the call requires edge processing (e.g., volumetric processing). The IMS AS 706 can decide to leverage local routing for a session. The IMS AS 706 discovers ECS in step 726 and the EES in step 728. Steps 726 and 728 are similar to the procedure in 3GPP TS 23558 and 3GPP TR 23794. As a result of this procedure, an edge UPF 710 is provisioned in an edge network 406 to receive content from end users. Two IMS AGW servers 712 assuming the role of 5G edge media application servers (Ass) are setup in the edge network 406. One IMS AGW server 712 is set up for each of the call participants (first UE 402A and second UE 402B). The remaining operations of the call are setup based on IMS specifications.

Media content is streamed from the first UE 402A to the first IMS AGW 412 where it is processed (e.g., volumetric processing). The processed volumetric video is then streamed to the second UE 402B for consumption. The same step as above happens between the second UE 402B and the second IMS AGW 412, then media processing and resultant volumetric video stream to first UE402A.

Although FIG. 7 illustrate a IMS two-way call 700 using a network edge, various changes may be made to FIG. 7. For example, the sizes, shapes, and dimensions of the IMS two-way call 700 and its individual components can vary as needed or desired. Also, the number and placement of various components of the IMS two-way call 700 can vary as needed or desired. In addition, the IMS two-way call 700 may be used in any other suitable volumetric conferencing process and is not limited to the specific processes described above.

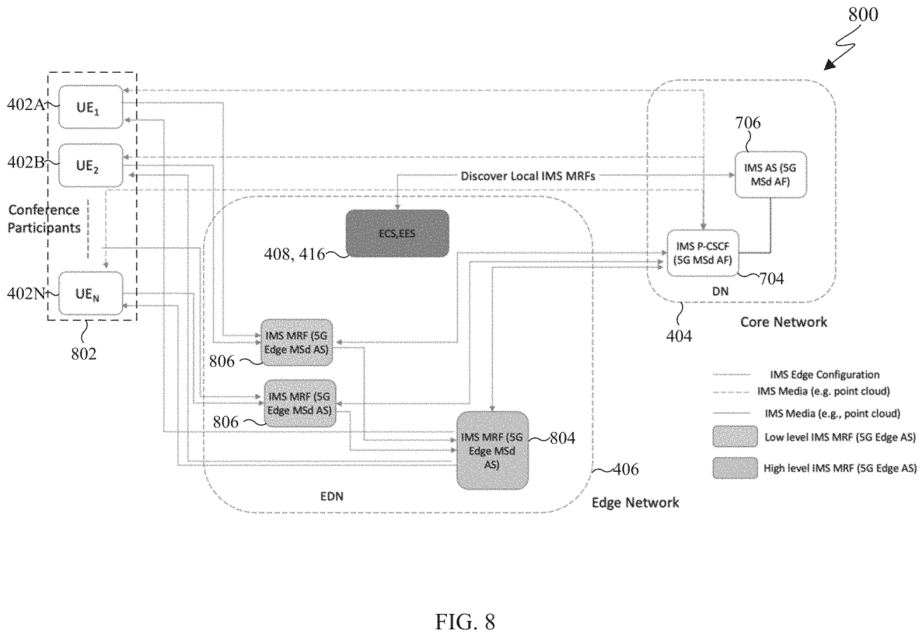

FIG. 8 illustrates an example IMS conference call 800 using a network edge in accordance with this disclosure. The embodiment of the IMS conference call 800 illustrated in FIG. 8 is for illustration only. FIG. 8 does not limit the scope of this disclosure to any particular implementation of an electronic device.

As shown in FIG. 8, conference calls 800 between multiple UEs 802 be enabled with volumetric content processing in a network edge, similar to a two-way call described in relation FIG. 6. IMS servers in the core network 404 (IMS AS 706 and IMS P-CSCF 704) can choose an edge application server 414 as described in 3GPP TS 23.558. The edge application server 414 should have IMS media resource function (MRF) capabilities described in 3GPP TS 24.147 and TS 24.229. The conference IMS MRF 804 which is a 5G edge AS serves as a higher-level media resource function to process media streams of all participants.

Each participant (such as participants associated with each of the first UE 402A, the second UE 402B, . . . , and the nth UE 402N) in an IMS conference call 800 is assigned a participant MRF 806 (5G Edge Media AS) in the network edge. The participant MRF 806 receives media data from the participant (UEs 402A-402N) and processes the received media stream before sending it to the intended destination. In IMS, since the media streams from individual participants are sent to the conference MRF 804 (e.g., for media mixing), the processed media stream from the respective media resource function of each participant is also sent to conference level MRF 804. Participant MRFs 804 assigned to each participant can do lower-level media processing (e.g., volumetric content processing such as composing three-dimensions (3D) objects with a background scene) before sending the volumetric media stream to the higher-level conference MRF 804. The higher-level conference MRF 804 can receive processed media streams of individual participants and can do a higher-level media processing (e.g., mixing of multiple scenes from multiple participants).

Although FIG. 8 illustrate a IMS conference call 800 using a network edge, various changes may be made to FIG. 8. For example, the sizes, shapes, and dimensions of the IMS conference call 800 and its individual components can vary as needed or desired. Also, the number and placement of various components of the IMS conference call 800 can vary as needed or desired. In addition, the IMS conference call 800 may be used in any other suitable volumetric conferencing process and is not limited to the specific processes described above.

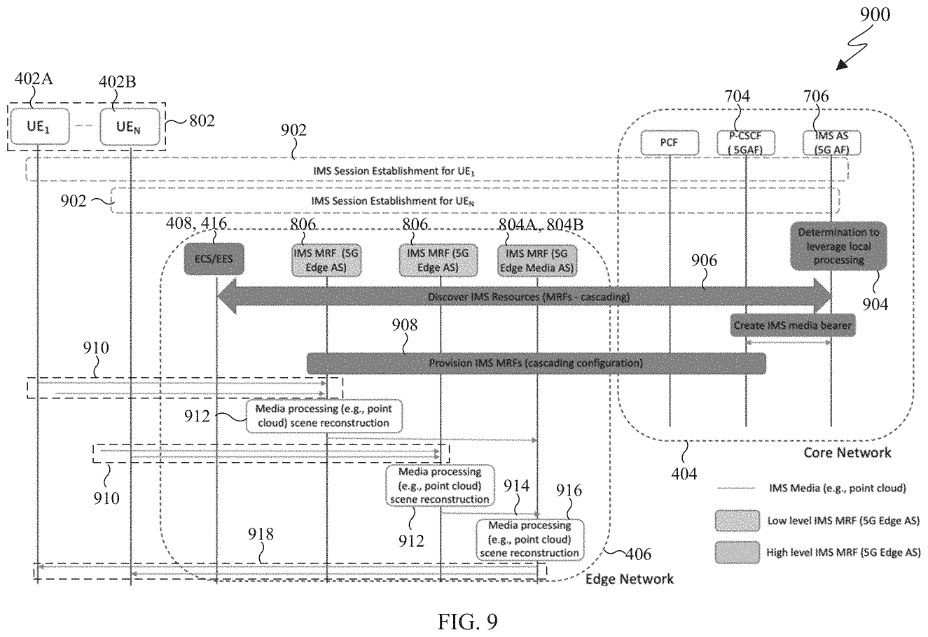

FIG. 9 illustrates an example message flow 900 for an IMS conference call using a network edge in accordance with this disclosure. The embodiment of the message flow 900 illustrated in FIG. 9 is for illustration only. FIG. 9 does not limit the scope of this disclosure to any particular implementation of an electronic device.

As shown in FIG. 9, the message flow 900 describes a procedure for setting up IMS conference calls 800 with volumetric processing in the edge network 406. In step 902, an IMS session is setup between the IMS AS 706, P-CSCF 704 and a first UE 402A. Step 820 is repeated for an IMS session to be set up between each of the multiple UEs 802 and the IMS AS706 and the P-CSCF 704. Steps 820 and 822 are described in 3GPP TS 24.147 and TS 24.229. Each of the multiple UEs 802 send a signaling message to the IMG AS 706. The signaling message can indicate a capability for each of the multiple UEs 802 related to volumetric processing. The volumetric abilities for each of the multiple UEs 802 can be different from others of the multiple UEs 802.

It is possible that some of the UEs in volumetric conference calls have limited terminal capacity. As a result, the UEs cannot process an incoming volumetric stream. In this case, during the signaling stage, each of the terminals indicate their capability to the conference server in the SIP header message. Alternatively, the capabilities of each of the participant terminals can be inferred using the SDP message in their request to join the conference. When the conference server receives an indication that one or more UEs in the conference call have limited capabilities, the conference server can enable setting up a video conversion task in the higher-level media server. The video conversion task in the higher-level media server will generate an additional representation by converting the resultant volumetric video to a 2D video. The 2D video is then sent to the UEs that indicated limited capability.

In step 904, the IMS AS 706 in core network 404 determines that the conference call requires edge processing (e.g., volumetric processing). The IMS decides to leverage local routing for session. As part of this step, the IMS AS 706 reviews the signaling messages for each of the multiple UEs 802. At least one of the signaling messages from the multiple UEs 802 can indicate volumetric processing for the conference. If at least one of the multiple UEs 802 indicates volumetric processing, then the IMS AS 706 can determine that the conference call requires edge processing.

In some embodiments, the conference call starts off as a regular 2D video call instead of starting of the IMS conference call by assigning a lower/higher-level media resource function to a user. When one or more UEs of the call prefer to have a volumetric conference, one of the UEs can request switching to a volumetric call. One option to signal this switch is to use a field called “switch-to-volumetric-conference” in the signaling message from a UE to the conference signaling server. Another alternative to request switching to volumetric call is to use the signaling mechanisms described in TS 24.147 and TS 24.229, which are to be enhanced to include the additional field called “switch-to-volumetric-conference”. In either of these cases, the value of this field is set to true. Once the conference signaling server receives an indication to switch the current conference call to a volumetric conference call, the media resource function starts allocation procedure(s) to each participant as described earlier. In certain embodiments, only a subset of UEs prefer to switch to volumetric conference while remaining UEs prefer to stay with a traditional 2D conference. In such an embodiment, the stream descriptions delivered to each of the media resource functions as described earlier are configured to satisfy the preferences of the participants.

In step 906, The IMS AS 706 discovers ECS 408 and EES 416. This procedure is described in 3GPP TS 23558 and 3GPP TR 23794, each of which are incorporated by reference. As a result of this procedure, edge UPFs (5G user plane function) are provisioned in edge network 406 to receive volumetric content from end users (the multiple UEs 802) in step 908. The IMG AS 706 can indicate a UPF for each of the multiple UEs 802 to transmit the volumetric content.

In step 908, multiple IMS MRF servers 804, 804A, 804B assuming the role of 5G Edge Media ASs are setup in the edge network 406. A lower-level participant IMS MRF 804 is set up for each the one or more multiple UEs 802. Higher-level conference IMS MRFs 804A, 804B are setup based on an amount of UEs in the multiple UEs 802. The rest of the conference call 800 is setup based on IMS specifications as described in TS 24.147 and TS 24.22.

In step 910, 3D volumetric content is streamed from one or more participants to each of participant MRFs 804 in the edge where the volumetric content is processed (e.g., mixing of 3D objects from connected participants). A participant IMS MRF 804 can perform processing of participant volumetric content for one or more of the multiple UEs 802. Depending on the number of the multiple UEs 802, there can be participant MRFs 804 in the edge network 406 and less higher-level conference MRFs 804A and 804B.

In step 912, processed volumetric content from each lower level MRF 804 is sent to a higher-level conference MRF 804 in the edge network 406 where the content gets processed (e.g., mixed) from multiple lower-level participant MRFs 804.

In steps 914, the conference MRFs 804A and 804B perform mixing functions of the processed participant volumetric data. First-level conference MRFs 804A can perform first stage mixing for the conference and second-level conference MRFs can perform second stage or final mixing for the conference. While only two levels of MRFs are illustrated, additional levels of conference MRFs can be implemented to handle larger conferences. As an illustrative example, a group of MRFs can process the conference information for a first UE 402A. The first-level conference MRFs 804A could be designed to mix participant data of an amount of the other UEs that are close in proximity at a first quality level and the second-level conference MRFs 804B could be designed to mix a larger amount of participant data related to a greater amount of UEs that are further in proximity to the first UE 402A. As another illustrative example, the first-level conference MRFs 804A can mix a standard quality for each of the multiple UEs 802, other than the first UE 402A, and the second-level conference MRFs 804B can mix a higher quality participant data for UEs that are closer in proximity. While proximity is used in both illustrative examples, other factors could be used to determine the difference between the first-level conference UEs 402A and the second-level conference UEs 402B. The participant volumetric content can also be mixed into a conference scene to generate conference content.

In step 918, the final processed conference content (e.g., 3D mixed content) is then delivered to the multiple UEs 802 for the conference. Each of the multiple UEs 802 can render and display the conference content for participants to attend the conference.

In some embodiments, IMS conferences are established as described in TS 24.147 and TS 24.229 without any network edge. Even in this case, the hierarchical media resource functions can be setup to process volumetric content from few to many users that are participating in the conference. One or more lower-level media resource functions can be assigned to one or more users and their volumetric captures be fused there before forwarding the partial scene to a higher-level media resource function. The higher-level media resource function takes care of completely reconstructing the final scene before it is sent to different participants either as volumetric content or compressed 2D video as described in main and other alternate embodiments of this invention.

Although FIG. 9 illustrate a message flow 900 for an IMS conference call using a network edge, various changes may be made to FIG. 9. For example, the sizes, shapes, and dimensions of the message flow 900 and its individual components can vary as needed or desired. Also, the number and placement of various components of the message flow 900 can vary as needed or desired. In addition, the message flow 900 may be used in any other suitable volumetric conferencing process and is not limited to the specific processes described above.

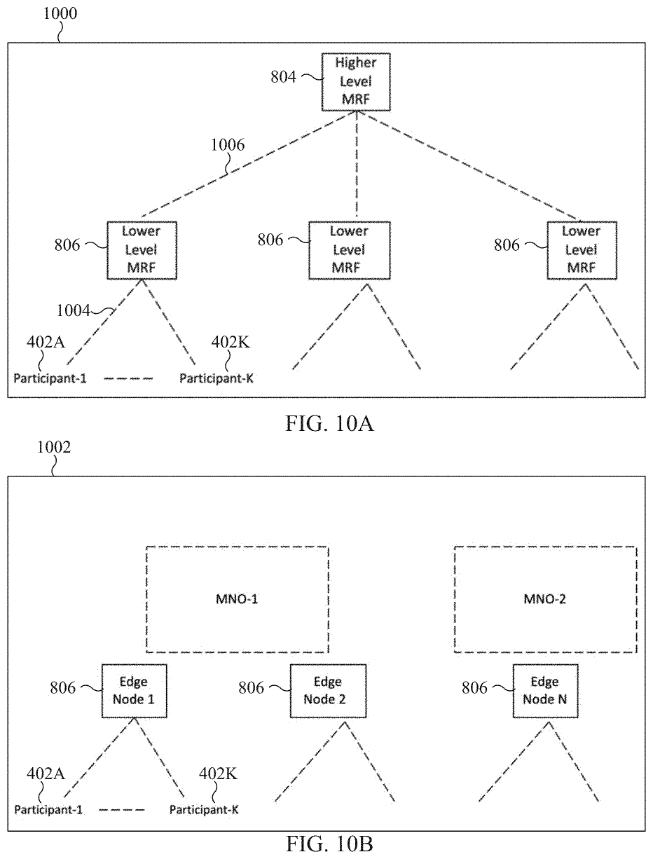

FIGS. 10A and 10B illustrate example media processing 1000, 1002 at multiple levels in accordance with this disclosure. The embodiment of the media processing 1000, 1002 illustrated in FIGS. 10A and 10B are for illustration only. FIGS. 10A and 10B do not limit the scope of this disclosure to any particular implementation of an electronic device.

As shown in FIG. 10A, IMS conferences using audio (e.g., using RTP) can have media streams mixed from multiple participants and the mixed media streams are sent to all participants using relatively low processing power and time. However, much more processing power and time are required for a video conference call with volumetric data. The extra processing power is due to the volumetric media streams from each participant used to build a 3D AR/MR scene where different participants are shown to be physically in the same meeting room even though each participant are in different locations.

To facilitate building of a scene to show the presence of all participants 402A-402N in the mixed reality (XR) conference the conference server starts off with an empty scene (or a scene description) big enough to accommodate the 3D object data (participant volumetric data) for a number of participants. Based on the number of participants and service requirements of the UEs related to the participants, the conference server provisions a number of lower-level and higher-level media resource functions (MRFs) in the edge network 406. Each edge node (participant MRF) 806 receives participant volumetric data 1004 of the participant UE 702A-402K and builds the 3D object data (participant volumetric data) 1004 of the participant into the empty scene. Processed scene contents 1006 are then sent to the higher-level media resource function node (conference MRF). The higher-level MRF nodes (conference MRFs) 804 receive one or more of processed media streams from lower-level media resource function nodes (participant MRFs) and fuse multiple 3D objects into the scene for the conference. This continues until up a hierarchy of media resource function nodes until the 3D objects of all the participants is fused into the 3D scene (conference volumetric content).

The scene description or the empty scene that is used for the conference can be based on a number of users to participate in the conference, meeting room environment details, background for the scene, relative position for each of the participants in comparison to other participants in the call or other locations in the meeting room, or any other suitable setting for a conference scene. The number of users to participate in the conference can be defined by a conference organizer and indicated to the conference server upon conference creations. The meeting room environment can include dimensions of the environment and view of the conference room. The background for the scene can include interested background for the scene. For example, the background could be a closed meeting room for focused meetings, a beach background for informal meetings, or any other suitable environment for a meeting. The background can be a still image or a video in 2D or 3D. The relative position for each of the participants can indicate a position and orientation of the 3D scene where the participant is inserted. This scene description can be communicated to the conference server upon joining the conference call (e.g., a participant would like to be placed beside another specific participant or a participant would like a specific position at the conference, such as head of a table). Based on the above factors, the conference server defines the initial empty scene and passes on this information to all lower-level media resource functions 806 that are assigned as media processing nodes receiving volumetric data from each of the participants.

For facilitating partial scene reconstruction at the lower-level media resource function 806 and completing scene reconstruction at higher-level MRFs 804, a scene template is generated by the application function. The scene template is shared with all media resource functions regardless of level. The scene template is defined by a scene description, partial scene descriptions, receiver list, and any other suitable definition for a scene template. The scene description can be provided to each media resource function with a list of stream descriptions that a media resource function is responsible for processing incoming volumetric content. Each stream description provides a description of incoming volumetric content stream from a call participant. Each stream description may have peer endpoint information, receiver endpoint information, incoming media format, outgoing media format, and any other suitable information related to a stream description. The peer endpoint information is endpoint information (IP addresses, port numbers) of the peer (user) generating volumetric stream. The receiver endpoint information is endpoint information (IP addresses, port numbers) where the media resource function receives the content streams. The incoming media format indicates a type of encoding format for the incoming media content (codecs, profiles, levels etc.). The outgoing media format indicates a type of encoding format for the outgoing media content should (codecs, profiles, levels etc.).

The partial scene description describes how to reconstruct videos/streams from multiple participants that a media resource function is directly responsible. The partial scene description is generated by the signaling application function that helped create the conference. The partial scene description is generated differently for each media resource function. The partial scene description of each media resource function is generated by inferring the users that are under the purview of the media resource function, and then extracting from the higher-level complete scene description the partial scene description that is needed.

The receiver list includes information about endpoints of receivers that to send the reconstructed video. A media resource function provisioned as a lower-level media resource function allows each of the receivers under the control of the media resource function to receive the video stream of partial scene reconstruction at the lower-level media resource function. Each of the users also simultaneously receives the final reconstructed video stream from higher-level media resource function.

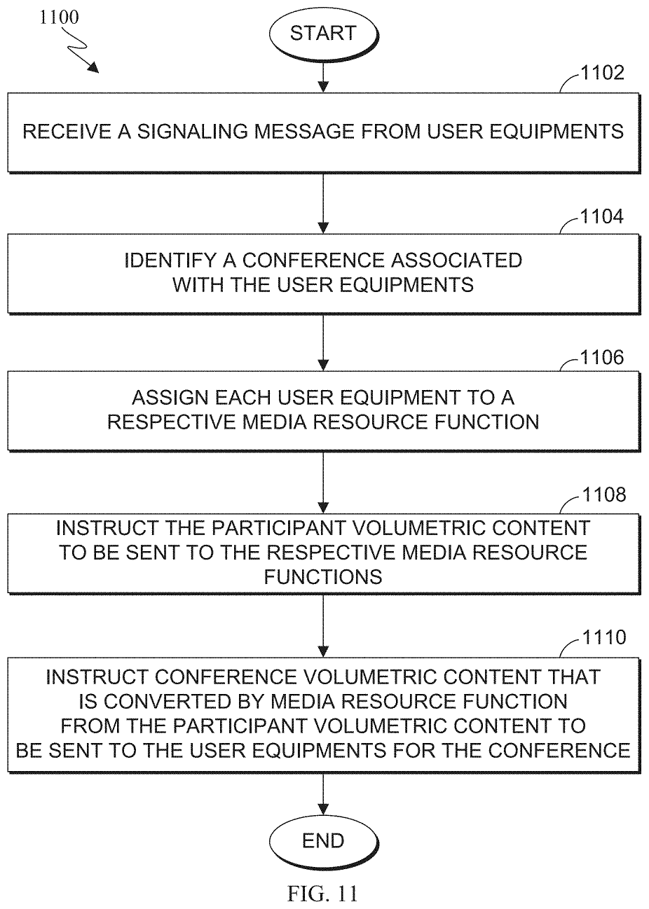

As shown in FIG. 10B, one edge MRF 806 can be assigned to more than one IMS conference participants as shown in FIG. 11. In this case, such a media resource function will process (e.g., volumetric mixing of contents) from multiple participants. A lower-level media resource function can process volumetric streams from a subset of UEs 402A-402K, and a higher-level media resource function can process the output of each of the above lower-level media resource functions to produce the final processed conference content (e.g., final mix of 3D objects, participant volumetric content, of all participants).

Although FIGS. 10A and 10B illustrate a media processing 1000, 1002 at multiple levels various changes may be made to FIGS. 10A and 10B. For example, the sizes, shapes, and dimensions of the media processing 1000, 1002 and their individual components can vary as needed or desired. Also, the number and placement of various components of the media processing 1000, 1002 can vary as needed or desired. In addition, the media processing 1000, 1002 may be used in any other suitable volumetric conferencing process and is not limited to the specific processes described above.

FIG. 11 illustrates an example method 1100 for systems and methods for volumetric conversational service using a network edge according to this disclosure. For ease of explanation, the method 1100 of FIG. 11 is described as being performed using server 104 and one or more client devices 106-116 of FIG. 1, server 200 of FIG. 2, and electronic device 300 of FIG. 3. However, the method 1100 may be used with any other suitable system and any other suitable servers, client device, or other electronic devices.

As shown in FIG. 11, the server 200 receives a signaling message from each of a plurality of UEs at step 1102. The signaling message indicates a capability of a UE to process participant volumetric content. The signaling message for a volumetric conferencing call can be received at the initiation of a conference call or during a 2D conference call. The signaling message can be different for each UE where a portion of UEs in the conference are experiencing a 2D conference call and another portion of UEs in the same conference are experiencing a 3D conference call.

The server 200 identifies a conference associated with the plurality of UEs for which volumetric processing is requested at step 1104. The server 200 can determine conference details from the signaling messages received from an initial UE to start a conference or cumulative message from one or more attending UEs. The server 200 provisions a number of media resource functions in the edge network 406 to process participant volumetric content received from one or more of the UEs and scene description received from the server 200. The server 200 also provisions a number of conference media resource functions for mixing processed participation volumetric content.

The server 200 assigns each UE to a respective media resource function at step 1106. Each UE is assigned to a participant media resource function to transmit volumetric data generated at the UE. More than one UE can be assigned to a specific participant media resource function.

The server 200 instructs the participant volumetric content from each UE to be sent to the respective media resource functions at step 1108. The UEs that are part of the conference begin streaming participant volumetric data to the respective participant media resource functions. The participant media resource functions process the participant volumetric content with a scene description for providing to one or more conference media resource functions. The conference media resource functions can include multiple levels for mixing process participants volumetric data based on a size of the conference.

The server 200 instructs conference volumetric content that is converted by the media resource functions from the participant volumetric content to be sent to the UEs for the conference at step 1110. The conference media resource functions can provide the final conference volumetric content to each of the UEs. The conference volumetric content can be different for each of the UEs based on only mixing the volumetric content of other UEs. In some embodiments, the conference volumetric content can include the participant volumetric data for all of the UEs in the conference and provides information in a header to indicate which of the conference volumetric data relates to the UE. The UE renders the conference volumetric data without rendering the conference volumetric data indicated in the header.

Although FIG. 11 illustrates one example of a method 1100 for systems and methods for volumetric conversational service using a network edge, various changes may be made to FIG. 11. For example, while shown as a series of steps, various steps in FIG. 11 may overlap, occur in parallel, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An apparatus for providing volumetric conversational services, the apparatus comprising:
a communication interface configured to receive a signaling message from each of a plurality of user equipment (UEs), the signaling messages indicating a capability of the plurality of UEs, respectively, to process participant volumetric content; and
a processor operably coupled to the communication interface, wherein the processor is configured to:
identify a conference associated with the plurality of UEs for which volumetric processing is requested,
provision a plurality of media resource functions in edge application servers of edge data networks for processing the participant volumetric content from the plurality of UEs,
assign one or more of the plurality of UEs to a respective media resource function of the plurality of media resource functions,
instruct the participant volumetric content from the plurality of UEs to be sent to the plurality of media resource functions, and
instruct conference volumetric content converted by the respective media resource functions to be sent to the one or more UEs for the conference.

2. The apparatus of claim 1, wherein:
the conference is initiated with an empty scene defined by an empty scene description,
the processor is further configured to:
provide the empty scene description to participant media resource functions for the participant media resource functions to generate a three-dimensional object of a participant into the empty scene using the empty scene description.

3. The apparatus of claim 2, wherein the processor is further configured to direct the participant media resource functions to transmit data for the three-dimensional object to at least one group media resource function to fuse into the empty scene with three-dimensional objects of other participants.

4. The apparatus of claim 2, wherein the empty scene description includes total participants or conference size, conference room dimensions, scene background information, participant locations, and participant orientations.

5. The apparatus of claim 3, wherein the processor is further configured to transmit a scene template to the participant media resource functions for standardizing construction of the three-dimensional object.

6. The apparatus of claim 5, wherein the scene template includes:
a stream description providing a description of a volumetric content stream from a participant,
a partial scene description providing a description of multiple volumetric contents that a media resource function is responsible for reconstructing, and
a receiver list including information about endpoints to send processed participant volumetric content.

7. The apparatus of claim 2, wherein, to provision the plurality of media resource functions, the processor is further configured to:
provision participant media resource functions where each is configured to process participant volumetric content for an assigned UE into the empty scene, and
provision at least one group media resource function configured to mix each participant volumetric content into the conference volumetric content for the conference.

8. The apparatus of claim 7, wherein, to provision the at least one group media resource function, the processor is further configured to instruct the at least one group media resource function to separate volumetric data for a specific UE when outputting the conference volumetric content to the specific UE.

9. A media resource function in an edge network, the media resource function comprising:
a communication interface configured to receive a signaling message from an apparatus in a core network to provision the media resource function for processing volumetric content from one or more user equipments (UEs), the signaling message indicating a capability of the one or more UEs assigned to the media resource function, respectively, to process participant volumetric content; and
a processor operably coupled to the communication interface, wherein the processor is configured to:
identify a conference associated with the one or more UEs for which volumetric processing is requested,
receive the participant volumetric content from the one or more UEs assigned to the media resource function,
mix the participant volumetric content with other participant volumetric content into conference volumetric content, and
transmit the conference volumetric content to the one or more UEs for the conference.

10. The media resource function of claim 9, wherein the processor is further configured to separate volumetric data for a specific UE when outputting the conference volumetric content to the specific UE.

11. The media resource function of claim 9, wherein:
the conference is initiated with an empty scene defined by an empty scene description, and
the processor is further configured to receive, from the apparatus in the core network, the empty scene description from the apparatus in the core network to generate a three-dimensional object of a participant into the empty scene using the empty scene description.

12. The media resource function of claim 11, wherein the processor is further configured transmit data for the three-dimensional object to another media resource function to fuse into the empty scene with three-dimensional objects of other participants.

13. The media resource function of claim 11, wherein the empty scene description includes total participants or conference size, conference room dimensions, scene background information, participant locations, and participant orientations.

14. The media resource function of claim 11, wherein the processor is further configured to receive, from the apparatus in the core network, a scene template for standardizing construction of the three-dimensional object.

15. The media resource function of claim 14, wherein the scene template includes:
a stream description providing a description of a volumetric content stream from a participant,
a partial scene description providing a description of multiple volumetric contents that a media resource function is responsible for reconstructing, and
a receiver list including information about endpoints to send processed participant volumetric content.

16. A user equipment (UE) for receiving volumetric conversational services, the UE comprising:
a communication interface; and
a processor operably coupled to the communication interface, the processor configured to:
transmit, to a network configuration server, a signaling message indicating capability of the UE to process participant volumetric content for a conference with a plurality of UEs;
receive, based on the signaling message, an assignment to a media resource function in an edge application server data network provisioned for processing the participant volumetric content for the UE;
transmit the participant volumetric content to the media resource function;
receive conference volumetric content converted from other participant volumetric content corresponding to one or more UEs for the conference by the media resource function; and
render the converted conference volumetric content for the conference.

17. The UE of claim 16, wherein the conference volumetric content includes the participant volumetric content and the other participant volumetric content for the one or more UEs mixed with an empty scene defined by an empty scene description.

18. The UE of claim 17, wherein the empty scene description includes total participants or conference size, conference room dimensions, scene background information, participant locations, and participant orientations.

19. The UE of claim 17, wherein:
the assignment to a media resource function includes an assignment to a participant media resource function and an assignment to a group media resource function,
to transmit the participant volumetric content, the processor is further configured to transmit the participant volumetric content to an assigned participant media resource function configured to process the participant volumetric content for the UE into the empty scene, and
to receive the conference volumetric content, the processor is further configured to receive the conference volumetric content mixed, by the group media resource function, with the process participant volumetric content for the UE with other participant volumetric content for other UEs for the conference.

20. The UE of claim 19, wherein the conference volumetric content received by the UE indicates a location of the UE for the conference in relation to the other participant volumetric content and excludes the participant volumetric content related to the UE.
